(19) United States
(12) Patent Application Publication
(10) Pub. No.: US 2024/0361598 A1
(43) Pub. Date: Oct. 31, 2024

(54) METHODS AND APPARATUSES FOR APPLYING ANTI-REFLECTIVE STRUCTURES TO AN AUGMENTED REALITY DISPLAY

(71) Applicant: GOOGLE LLC, Mountain View, CA (US)

(72) Inventors: Qinglan Huang, Mountain View, CA (US); Wei Jin, Saratoga, CA (US); Joseph Daniel Lowney, Tucson, AZ (US)

(21) Appl. No.: 18/139,603

(22) Filed: Apr. 26, 2023

(51) Int. Cl. G02B 27/01

(52) U.S. Cl. CPC G02B 27/0172; G02B 2027/0178

(57) ABSTRACT

Methods and apparatuses for applying anti-reflective structures to a waveguide of an augmented reality display device include producing two initial molds: one formed with high precision for diffractive optical structures, and one formed with lower precision for anti-reflective structures. The two initial molds are imprinted into a single resist layer to form an integrated mold, which is then usable to simultaneously form both diffractive optical structures and anti-reflective structures. Accordingly, the cost of producing the anti-reflective structures is minimized while the efficiency of forming the diffractive optical structures and anti-reflective structures is maximized.

### BACKGROUND

The present disclosure relates generally to an augmented reality (AR) eyewear display. In an AR eyewear display, light from an image source is coupled into a light guide substrate, generally referred to as a waveguide, by an input optical coupling such as an in-coupling grating (i.e., an “incoupler”), which can be formed on a surface, or multiple surfaces, of the substrate or disposed within the substrate. Once the light beams have been coupled into the waveguide, the light beams are “guided” through the substrate, typically by multiple instances of total internal reflection, to then be directed out of the waveguide by an output optical coupling (i.e., an “outcoupler”), which can also take the form of an optical grating. The light beams projected from the waveguide overlap at an eye relief distance from the waveguide forming an exit pupil within which a virtual image generated by the image source can be viewed by the user of the eyewear display.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing moth eye nanopillar anti-reflective structures that are nanoimprinted in non-grating regions of a waveguide in accordance with some embodiments.

FIG. 2 is a diagram illustrating a cross-section view of an example implementation of a waveguide in accordance with some embodiments.

FIG. 3 is a block diagram showing a perspective view of anti-reflective structures on an augmented reality display in accordance with some embodiments.

FIG. 4 is a block diagram showing an elevation view of anti-reflective structures and a graph of effective refractive index as light passes through the anti-reflective structures in accordance with some embodiments.

FIG. 5 is a block diagram showing an elevation view of a mold defining diffractive optical structures in accordance with some embodiments.

FIG. 6 is a block diagram showing an elevation view of a mold defining anti-reflective structures in accordance with some embodiments.

FIG. 7 is a flow diagram of a method of fabricating an integrated mold defining a diffractive optical structure and an anti-reflective structure in accordance with some embodiments.

FIG. 8 is a block diagram of a method of simultaneously imprinting a diffractive optical structure and an anti-reflective structure into a substrate.

### DETAILED DESCRIPTION

Eyewear display devices potentially have multiple practical and leisure applications, but the development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

The gratings used for incoupling, outcoupling, and expanding light within a waveguide of an eyewear display device typically have highly reflective surfaces made of high index polymer. The high reflection leads to undesirable optical effects such as rear view or cosmetic artifacts, which can negatively impact the user experience. To reduce undesirable reflections and thereby increase image quality, anti-reflective coatings and structures are often applied to one or more surfaces of an augmented reality display. However, these coatings or structures are typically expensive or time consuming to apply. For example, traditional anti-reflective coatings consist of multiple microscopic layers of metallic oxides of alternating high and low index of refraction. Because each layer affects different wavelengths of light, the more layers that are used, the more reflections are neutralized, with some anti-reflective coatings having up to seven layers. The anti-reflection coatings are typically applied by block lithography, which involves an expensive process of depositing layers of thin films on a substrate of the waveguide while protecting existing incoupler and outcoupler gratings. The process flow for block lithography is complex and prone to defects.

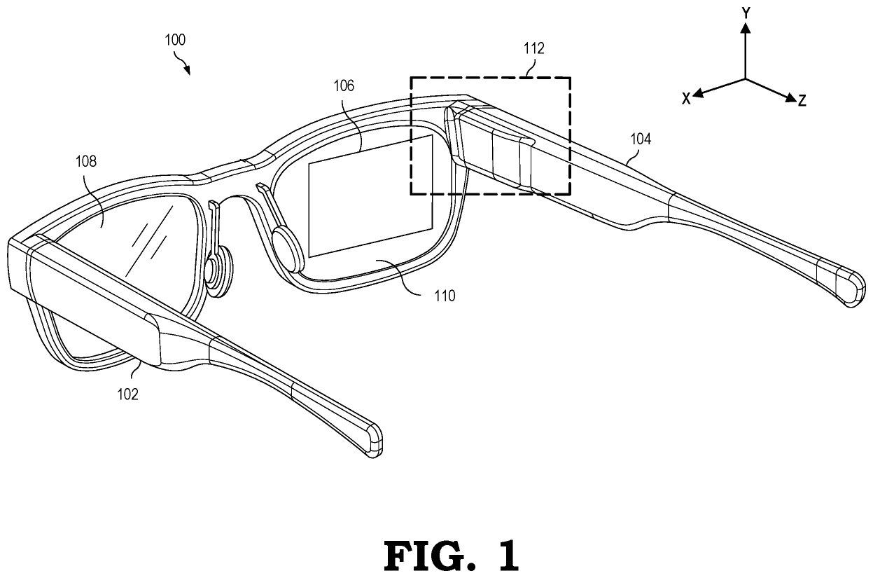

FIGS. 1-8 illustrate techniques for applying anti-reflective structures to an augmented reality display without the use of lithography. In some embodiments, the anti-reflective structures are moth eye nanopillars that are patterned on silicon wafer through etch in a large pattern and then transferred to a glass substrate through nanoimprint in the same step as other diffractive optical elements. In order to apply such anti-reflective structures quickly and economically in an augmented reality display, in some embodiments two initial molds are produced: one for diffractive optical structures, which require higher precision and relatively more expensive techniques, and one for anti-reflective structures, which require lower precision and is therefore able to be fabricated using less expensive techniques. The two initial molds are imprinted (e.g., nanoimprinted) into a single resist layer to form an integrated mold, which is then usable to simultaneously form both diffractive optical structures and anti-reflective structures. Accordingly, the cost of producing the integrated mold is minimized and the efficiency of forming the diffractive optical structures and anti-reflective structures is maximized.

As an example of an AR eyewear display system, FIG. 1 illustrates an example AR eyewear display system 100 implementing moth eye nanopillar anti-reflective structures that are nanoimprinted in non-grating regions of a waveguide in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the augmented reality display system 100 are fully or partially contained within an inner volume of support structure 102, such as within the arm 104 in region 112 of the support structure 102. In the illustrated implementation, the AR eyewear display system 100 utilizes a spectacles or eyeglasses form factor. However, the AR eyewear display system 100 is not limited to this form factor and thus may have a different shape and appearance from the eyeglasses frame depicted in FIG. 1.

One or both of the lens elements 108, 110 are used by the augmented reality display system 100 to provide an augmented reality display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) in the light path between the IC and OC, or in combination with the OC, in order to increase the dimensions of the display exit pupil. In some embodiments, the regions of the waveguide outside the IC and OC or EPE/OC grating regions are nanoimprinted with moth eye nanopillars to reduce reflections from the waveguide surface. Moreover, each of the lens elements 108, 110 is sufficiently transparent to allow a user to see through the lens elements to provide a field of view of the user's real-world environment such that the image appears superimposed over at least a portion of the real-world environment.

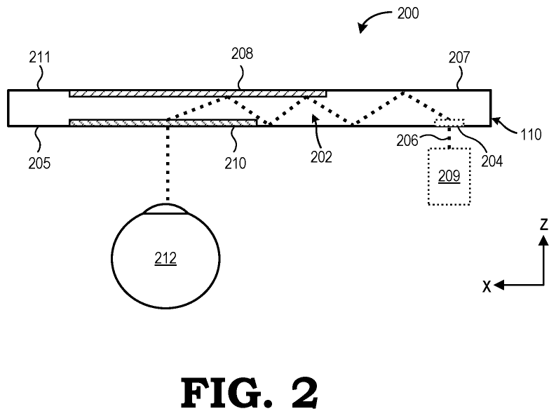

FIG. 2 depicts a cross-section view 200 of an implementation of a lens element 110 of an AR eyewear display system such as AR eyewear display system 100. Note that for purposes of illustration, at least some dimensions in the Z direction are exaggerated for improved visibility of the represented aspects. In this example implementation, the waveguide 202 implements diffractive optical structures in the region 208 on the opposite side of the waveguide 202 as the diffractive optical structures of the region 210. In particular, the diffractive optical structures of the IC 204 are implemented on the eye-facing side 205 of the lens element 110. Likewise, the diffractive optical structures of region 210 (which provide OC functionality) are implemented at the eye-facing side 205. Further in this implementation, the diffractive optical structures of region 208 (which provide EPE functionality) is implemented at the world-facing side 207 of the lens element 110 opposite the eye-facing side 205. Thus, under this approach, display light 206 from a light source 209 is incoupled to the waveguide 202 via the IC 204, and propagated (through total internal reflection in this example) toward the region 208, whereupon the diffractive optical structures of the region 208 diffract the incident display light for exit pupil expansion purposes, and the resulting light is propagated to the diffractive optical structures of the region 210, which output the display light toward a user's eye 212. In other implementations, the regions 208 and 210 may switch sides, with the diffractive optical structures of region 210 formed on the world-facing side 207 and the diffractive optical structures of region 208 formed on the eye-facing side 205, however, this may result in the regions 208 and 210 having different positions, dimensions, and shapes, and also may require diffractive optical structures in each region to have different characteristics. In some embodiments, one or more external regions of the lens element 110 outside of region 208 and/or region 210 on one or both of the world-facing side 207 and eye-facing side 205, such as region 211, are nanoimprinted with moth eye nanopillars to reduce reflections from the waveguide surface.

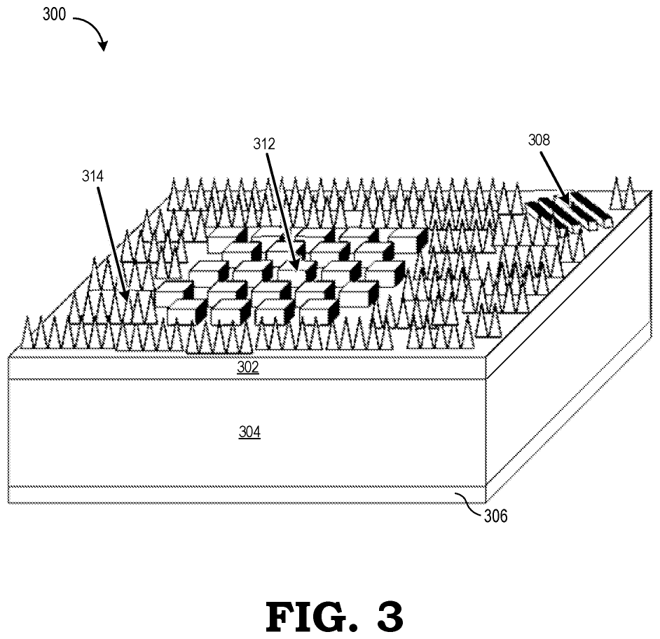

FIG. 3 is a block diagram showing a perspective view of anti-reflective structures 314 on an AR display 300 in accordance with some embodiments. In this example, the AR display 300 includes a polymer layer 302, a glass layer 304, a coating layer 306, an IC 308, and an OC 312. In order to reduce undesirable reflections, anti-reflective structures 314 are provided in non-grating regions on the surface of the polymer layer 302. In some embodiments, the anti-reflective structures 314 comprise a plurality of tapered rods, nanopillars, or cones. Tapered rods, nanopillars, or cones are effective in reducing reflections due to the gradient effective medium formed by a gradual refractive index transition from, e.g., air to a substrate along the length of the structures. In order to apply anti-reflective structures 314 to the AR display 300, in some embodiments, two separate molds are fabricated: a first mold for imprinting a diffractive optical structure, which requires high precision to ensure proper functionality; and a second mold for imprinting an anti-reflective structure into a substrate, which does not require as high precision. An integrated mold is then formed using the first and second molds, and the integrated mold is then usable to simultaneously imprint a diffractive optical structure and an anti-reflective structure into a substrate, as described further herein.

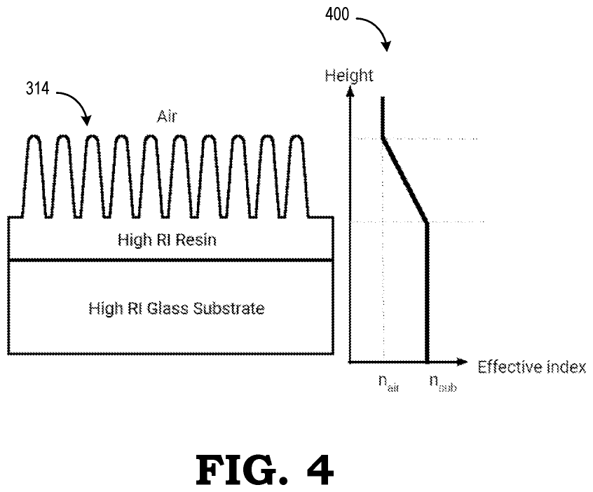

FIG. 4 is a block diagram showing an elevation view of anti-reflective structures 314 and a graph 400 of the effective refractive index of the anti-reflective structures 314 as light passes through in accordance with some embodiments. In some embodiments, the subwavelength scale anti-reflective structures 314 form a gradient effective medium with an upper region refractive index close to air and a lower region refractive index close to the substrate on which the anti-reflective structures 314 are provided. The gradual refractive index transition from air to substrate efficiently reduces the interface reflection.

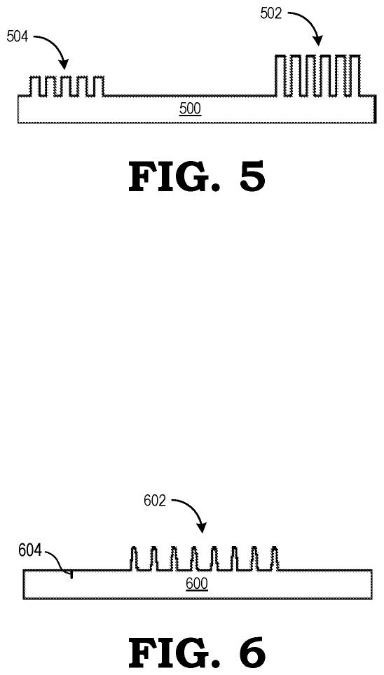

FIG. 5 is a block diagram showing an elevation view of a first mold 500 defining diffractive optical structures in accordance with some embodiments. In some embodiments, the diffractive optical structures include an IC defining portion 502 and/or an OC defining portion 504. As these diffractive optical structures typically require relatively high precision to ensure proper functionality, in some embodiments, the first mold 500 is fabricated using photolithography and/or electron-beam lithography on, e.g., a quartz substrate.

FIG. 6 is a block diagram showing an elevation view of a second mold 600 with an anti-reflective structure defining portion 602 in accordance with some embodiments. As noted above, in some embodiments, the anti-reflective structures 314 comprise a plurality of tapered rods, nanopillars, or cones. The anti-reflective structure defining portion 602 provides structures identical to the anti-reflective structures 314 desired to be applied to an augmented reality display. In some embodiments, the anti-reflective structure defining portion 602 of the second mold 600 is fabricated using block copolymer self-assembly and plasma etching. For example, in some embodiments, monolayer silica colloidal crystals with non-close-packed structures are deposited on a substrate using a spin-coating technique, which deposits a monolayer colloidal crystal consisting of about 360 nm diameter silica spheres. The silica particles are then used as etching masks during a sulfur hexafluoride (SF6) reactive ion etching process to pattern arrays of tapered rods directly on silicon. The silica spheres are then removed by a hydrofluoric acid wash, leaving behind anti-reflective structures like anti-reflective structures 314. In some embodiments, sizes and aspect ratios of the anti-reflective structures 314 are tuned by varying the diameter of the silica spheres and/or the ion etching processing time. However, in some embodiments, the tapered rods of the second mold 600 are fabricated using photolithography and/or electron-beam lithography, e.g., at accelerated lithography speeds or rates and/or reduced precision relative to the photolithography and/or electron-beam lithography used to fabricate the first mold 500.

In some embodiments, the tapered rods of the anti-reflective structures 314 each have a maximum diameter of about 60 nanometers and a height of about 250 nanometers. In some embodiments, the tapered rods of the anti-reflective structures 314 each have an average diameter of about 30 nanometers and a height of about 200-300 nanometers. In some embodiments, the tapered rods of the anti-reflective structures 314 each have a minimum diameter of about 10 nanometers. Generally, the tapered rods of the anti-reflective structures 314 are tuned by varying the radius, the height, and/or the aspect ratio of height to width in order to achieve desired characteristics. In some embodiments, the tapered rods comprise a resin having a refractive index of 1.5 to 2. In some embodiments, the tapered rods comprise a resin having a refractive index of about 1.7. In some embodiments, one or both of the first mold 500 and the second mold 600 include an alignment mark like alignment mark 604, which is usable to ensure proper alignment between the impressions formed by the molds, as described further below. In some embodiments, the alignment mark 604 is one of a visible marking, a marking visible only under ultraviolet or infrared light, or a physical indentation or protrusion.

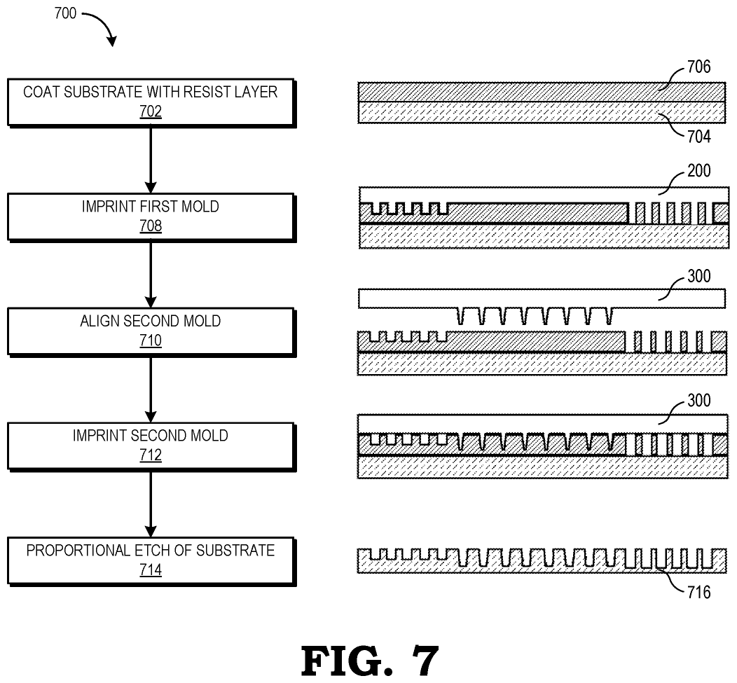

FIG. 7 is a flow diagram of a method 700 of fabricating an integrated mold defining a diffractive optical structure and an anti-reflective structure in accordance with some embodiments. At block 702, a substrate 704 is coated with a resist layer 706. At block 708, the first mold 500 is imprinted into the resist layer 706, which, in some embodiments, includes local ultraviolet curing of the resist layer 706. The first mold 500 is then demolded or removed from the resist layer 706. At block 710, the second mold 600 is aligned with the resist layer 706. In some embodiments, the aligning is performed based on one or more markings on one or more of the first mold 500 and the second mold 600, like the alignment mark 604 shown in FIG. 6. In some embodiments, the alignment mark 604 is aligned with a portion of the resist layer 706 and/or an impression of one of the first mold 500 and the second mold 600 in the resist layer 706 in order to ensure proper relative positioning of the impressions formed by the molds. For example, in some embodiments, the resist layer 706 includes a similar marking (not shown) that a user or manufacturing tool aligns with the alignment mark 604 on the first mold 500 and/or the second mold 600 to prevent positioning errors.

At block 712, the second mold 600 is imprinted into the resist layer 706, which, in some embodiments, includes local ultraviolet curing of the resist layer 706. At block 714, a proportional etch procedure is performed on the substrate 704 based on the resist layer 706 to create an integrated mold 716. As shown in FIG. 7, the first mold 500 imprints into a first region of the resist layer 706 and the second mold 600 imprints into a second, nonoverlapping region of the resist layer 706 such that anti-reflective structures like anti-reflective structures 314 are only placed in regions outside of diffractive optical structures, such as IC 308 and OC 312. As also shown in FIG. 7, after method 700 is performed, the resulting integrated mold 716 defines or includes impressions of both the first mold 500 and the second mold 600 and so is designed to imprint diffractive optical structures (e.g., IC 308 and OC 312 of FIG. 3) and an anti-reflective structure (e.g., anti-reflective structures 314 of FIG. 3) into a substrate.

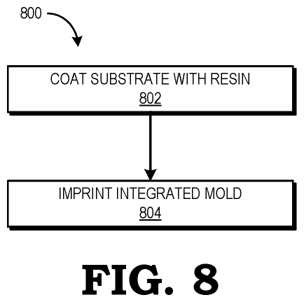

FIG. 8 is a block diagram of a method 800 of simultaneously imprinting a diffractive optical structure and an anti-reflective structure into a substrate. At block 802, a substrate is coated with resin. At block 804, an integrated mold like integrated mold 716 of FIG. 7 is imprinted into the resin, which results in simultaneously imprinting a diffractive optical structure (e.g., IC 308 and/or OC 312 of FIG. 3) and an anti-reflective structure (e.g., anti-reflective structures 314 of FIG. 3) into the substrate of resin. In some embodiments, after the integrated mold 716 is imprinted into the resin, local ultraviolet curing of the resist layer 706 is performed before demolding the integrated mold 716 from the resin. In some embodiments, the anti-reflective structures 314 are provided on an eye-side surface, world-side surface, or both an eye-side and a world-side surface of an augmented reality display. Accordingly, using method 800, reflections are able to be reduced on any desired surface (e.g., world-side or eye-side) of an augmented reality display, such as one or more lens elements 108, 110 of the augmented reality display 100 of FIG. 1. In some embodiments, as shown in FIG. 3, an coating layer 306 is provided on one surface of a lens element by a manufacturer, which in some embodiments provides anti-reflective functionality such that adding anti-reflective structures using a method like method 800 is not required on the surface of the coating layer 306.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
an integrated mold designed to imprint a diffractive optical structure and an anti-reflective structure into a substrate.

2. The apparatus of claim 1, wherein the anti-reflective structure includes a plurality of tapered rods.

3. The apparatus of claim 2, wherein the plurality of tapered rods each have a maximum diameter of about 60 nanometers and a height of about 250 nanometers.

4. The apparatus of claim 2, wherein the plurality of tapered rods comprises a resin having a refractive index of 1.5 to 2.

5. The apparatus of claim 1, wherein the diffractive optical structure is an optical grating, incoupler, or outcoupler.

6. A method comprising:
simultaneously imprinting a diffractive optical structure and an anti-reflective structure into a substrate.

7. The method of claim 6, further comprising performing the imprinting using an integrated mold.

8. The method of claim 7, wherein the integrated mold defines the diffractive optical structure and the anti-reflective structure.

9. The method of claim 6, wherein the anti-reflective structure includes a plurality of tapered rods.

10. The method of claim 9, wherein the plurality of tapered rods each have a maximum diameter of about 60 nanometers and a height of about 250 nanometers.

11. The method of claim 9, wherein the plurality of tapered rods comprises a resin having a refractive index of 1.5 to 2.

12. A method comprising:
fabricating a first mold for defining a diffractive optical structure;
fabricating a second mold for defining an anti-reflective structure; and
using the first mold and the second mold, fabricating an integrated mold for defining the diffractive optical structure and the anti-reflective structure.

13. The method of claim 12, wherein fabricating the integrated mold comprises imprinting the first mold and the second mold into a substrate.

14. The method of claim 13, wherein imprinting the first mold and the second mold into the substrate comprises:
imprinting a first one of the first mold and the second mold into the substrate;
aligning the second one of the first mold and the second mold with the substrate; and
imprinting the second one of the first mold and the second mold into the substrate.

15. The method of claim 14, wherein the aligning includes aligning an alignment mark on the second one of the first mold and the second mold with a portion of the substrate.

16. The method of claim 14, wherein:
the imprinting the first one of first mold and the second mold into the substrate is in a first region of the substrate; and
the imprinting the second one of the first mold and the second mold into the substrate is in a second region of the substrate, wherein the first region and second region are nonoverlapping.

17. The method of claim 12, wherein the anti-reflective structure includes a plurality of tapered rods.

18. The method of claim 17, wherein the plurality of tapered rods each have a maximum diameter of about 60 nanometers and a height of about 250 nanometers.

19. The method of claim 17, wherein the plurality of tapered rods comprises a resin having a refractive index of 1.5 to 2.

20. The method of claim 12, further comprising imprinting the diffractive optical structure and the anti-reflective structure into a substrate using the integrated mold.
